(19) United States
(12) Patent Application Publication
(10) Pub. No.: US 2004/0258014 A1
(43) Pub. Date: Dec. 23, 2004

(54) Apparatus and method for assigning a dedicated pilot channel for identification of a base station in an OFDM communication system

(75) Inventors: Jung-Min Ro, Seoul (KR); Seok Hyun Yoon, Seoul (KR); Seong-Ill Park, Seongnam-si (KR); Pan-Yuh Joo, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/872,893

(22) Filed: Jun. 21, 2004

(30) Foreign Application Priority Data
Jun. 20, 2003 (KR) P2003-40390

(51) Int. Cl. H04Q 7/00

(52) U.S. Cl. 370/328

(57) ABSTRACT

In a wireless communication system that divides an entire frequency band into a plurality of subcarrier bands, transmits reference signals at the subcarrier bands, and transmits data signals at subcarrier bands other than the subcarrier bands at which the reference signals are transmitted, a base station assigns the subcarrier band at which the reference signals are transmitted as a frequency band dedicated to the reference signals; and transmits the reference signals through the assigned reference signal-dedicated frequency band.

### PRIORITY

This application claims priority under 35 U.S.C. § 119 to an application entitled “Apparatus and Method for Assigning Dedicated Pilot Channel for Identification of Base Station in an OFDM Communication System” filed in the Korean Intellectual Property Office on Jun. 20, 2003 and assigned Ser. No. 2003-40390, the contents of which are incorporated herein by reference.

### BACKGROUND OF THE INVENTION

1. Field of the Invention

The present invention relates generally to a communication system employing an Orthogonal Frequency Division Multiplexing (OFDM) scheme, and in particular, to an apparatus and method for generating a pilot pattern for the identification of base stations.

2. Description of the Related Art

In an Orthogonal Frequency Division Multiplexing (OFDM) scheme used for high-speed data transmission over wired/wireless channels, data is transmitted using multiple carriers. The OFDM scheme is a Multi-Carrier Modulation (MCM) scheme for parallel-converting a serial input symbol stream and modulating the parallel-converted symbols with multiple orthogonal subcarriers, or multiple orthogonal subchannels.

The first MCM systems appeared in the late 1950's for military high frequency (HF) radio communications, and the OFDM scheme for overlapping orthogonal subcarriers was initially developed in the 1970's. In view of orthogonal modulation between multiple carriers, the OFDM scheme has limitations related to the actual implementation of the systems. In 1971, Weinstein, et. al. proposed that OFDM modulation/demodulation can be efficiently performed using Discrete Fourier Transform (DFT), which was a driving force behind the development of the OFDM scheme. Also, the introduction of a guard interval and a cyclic prefix as the guard interval further mitigates adverse effects of multipath propagation and delay spread on the systems.

The OFDM scheme has widely been exploited for digital data communication technologies such as digital audio broadcasting (DAB), digital TV broadcasting, wireless local area network (WLAN), and wireless asynchronous transfer mode (WATM). Although hardware complexity was an obstacle to wide use of the OFDM scheme, recent advances in digital signal processing technology including fast Fourier transform (FFT) and inverse fast Fourier transform (IFFT) enable the OFDM scheme to be implemented. The OFDM scheme, similar to an existing Frequency Division Multiplexing (FDM) scheme, boasts of optimum transmission efficiency in high-speed data transmission because it transmits data on subcarriers, while maintaining orthogonality among them. The optimum transmission efficiency is further attributed to efficient frequency use and robustness against multipath fading in the OFDM scheme.

Overlapping frequency spectrums lead to efficient frequency use and robustness against frequency selective fading and multipath fading. The OFDM scheme reduces effects of intersystem interference (ISI) through the use of guard intervals and enables design of a simple equalizer hardware structure. Furthermore, since the OFDM scheme is robust against impulse noise, it is increasingly popular in communication systems.

A description will now be made of operations of a transmitter and a receiver for a communication system employing the OFDM scheme (hereinafter referred to as an “OFDM communication system”).

In a transmitter for the OFDM communication system, input data is modulated with subcarriers through a scrambler, an encoder and an interleaver. The transmitter provides a variable data rate, and has a different coding rate, interleaving size and modulation scheme according to the data rate.

Commonly, the encoder uses a coding rate of ½ or ¾, and an interleaver size for preventing a burst error is selected according to the number of coded bits per OFDM symbol (NCBPS). As the modulation scheme, one of quadrature phase shift keying (QPSK), 8-ary phase shift keying (8 PSK), 16-ary quadrature amplitude modulation (16 QAM) and 64 QAM schemes is used according to the data rate.

A predetermined number of pilot subcarriers are added to a signal modulated with a predetermined number of subcarriers by the above-stated elements, and then generated into one OFDM symbol through an inverse fast Fourier transform (IFFT) block. In the IFFT block, a guard interval for removing inter-symbol interference in a multipath channel environment is inserted into the OFDM symbol, and the guard interval-inserted OFDM symbol is finally input to a radio frequency (RF) processor through a symbol generator. The RF processor converts the input signal into an RF signal and transmits the RF signal over the air.

In a receiver for the OFDM communication system, a reverse process at that which was performed in the transmitter is performed, and a synchronization process is added thereto. The receiver estimates a frequency offset and a symbol offset for a received OFDM symbol using a predetermined training symbol. Thereafter, a guard interval-removed data symbol is demodulated with a plurality of subcarriers to which a plurality of pilot subcarriers are added, through a fast Fourier transform (FFT) block.

Further, in order to cope with path delay on an actual radio channel, an equalizer estimates a channel condition for a received channel signal and removes signal distortion on the actual radio channel from the received channel signal according to the estimated channel condition. Data channel-estimated through the equalizer is converted into a bit stream, and then input to a de-interleaver. Thereafter, the de-interleaved bit stream is output into final data through a decoder and a de-scrambler for error correction.

As described above, in the OFDM communication system, a transmitter, or a base station (BS), transmits pilot subcarrier signals to a receiver, or a mobile station (MS). The base station transmits data subcarrier signals (hereinafter referred to as “data channel signals”) together with the pilot subcarrier signals. The reason for transmitting the pilot subcarrier signals is for synchronization acquisition, channel estimation, and base station identification.

The pilot subcarrier signals serve as a training sequence, and are used for performing channel estimation between a transmitter and a receiver. Further, mobile stations can identify their base stations using the pilot subcarrier signals. Points where the pilot subcarrier signals are transmitted are predetermined by the transmitter and the receiver. As a result, the pilot channel signals serve reference signals.

A description will now be made of a process in which a mobile station identifies its base station using the pilot subcarrier signals.

A base station transmits the pilot subcarrier signals at a power level to a cell boundary with relatively high transmission power (e.g., 3 dB or higher), compared with the data channel signals, while having a particular pattern, or a pilot pattern.

The reason for transmitting by the base station the pilot subcarrier signals such that they can reach up to the cell boundary while having a particular pilot pattern is as follows. A mobile station, when it enters a cell, has no information on its current base station. In order to detect its base station, the mobile station must use the pilot subcarrier signals. Therefore, the base station transmits the pilot subcarrier signals in a particular pilot pattern with relatively high transmission power so that the mobile station can detect its base station.

The “pilot pattern” is a pattern in which pilot subcarrier signals transmitted by the base station are generated. That is, the pilot pattern is distinguished by a slope of the pilot subcarrier signals and a transmission start point of the pilot subcarrier signals. Therefore, the OFDM communication system should be designed such that base stations have their own predetermined pilot patterns for their identification.

In addition, the pilot pattern is generated by taking into account a coherence bandwidth and a coherence time. A description will now be made of the coherence bandwidth and the coherence time.

The coherence bandwidth represents a maximum bandwidth where it can be assumed that a channel is constant, in a frequency domain. The coherence time represents a maximum time where it can be assumed that, a channel is constant, in a time domain.

Because it can be assumed that a channel is constant within the coherence bandwidth and coherence time, even though only one pilot subcarrier signal is transmitted within the coherence bandwidth and coherence time, it is sufficient for synchronization acquisition, channel estimation, and base station identification. As a result, it is possible to maximize transmission of data channel signals, thereby contributing to the improvement in entire system performance.

In conclusion, a maximum frequency interval for transmitting pilot subcarrier signals is a coherence bandwidth, and a maximum time interval, or a OFDM symbol time interval for transmitting the pilot channel signals is a coherence time.

The number of base stations constituting the OFDM communication system is varied according to the size of the OFDM communication system, and the number of the base stations increases as a size of the OFDM communication system increases. Therefore, in order to identify all of the base stations, the number of pilot patterns having different slopes and different start points should be identical to the number of the base stations.

However, in the OFDM communication system, in order to transmit a pilot subcarrier signal in a time-frequency domain, the coherence bandwidth and the coherence time should be considered. When the coherence bandwidth and the coherence time are considered, the pilot patterns having different slopes and different start points are restrictively generated.

When pilot patterns are generated by the base station without considering the coherence bandwidth and the coherence time, pilot subcarrier signals in the pilot patterns representing different base stations coexist. In this case, it is not possible to identify a base station using the pilot patterns.

With reference to FIG. 1, a pilot pattern for an OFDM communication system using one pilot channel will now be described.

FIG. 1 is a diagram illustrating points where pilot subcarrier signals based on a particular pilot pattern are transmitted in a common OFDM communication system using one pilot channel.

Before a description of FIG. 1 is given, it is noted that in FIG. 1 that circles shown in FIG. 1 represent points where pilot subcarrier signals are actually transmitted, and transmission points of the pilot subcarrier signals are expressed in the form of “(time domain, frequency domain)”. Referring to FIG. 1, a first pilot subcarrier signal is transmitted at a (1,1) point 101, a second pilot subcarrier signal is transmitted at a (2,4) point 102, a third pilot subcarrier signal is transmitted at a (3,7) point 103, a fourth pilot subcarrier signal is transmitted at a (4,10) point 104, a fifth pilot subcarrier signal is transmitted at a (5,2) point 105, a sixth pilot subcarrier signal is transmitted at a (6,5) point 106, a seventh pilot subcarrier signal is transmitted at a (7,8) point 107, and an eighth pilot subcarrier signal is transmitted at a point (8,11) 108. It is assumed in FIG. 1 that 8 OFDM symbols constitute one OFDM frame, and 8 pilot subcarrier signals constitute one pilot channel.

In the pilot pattern shown in FIG. 1, the start point is (1,1) 101 and its slope is 3. That is, a pilot subcarrier signal is transmitted at the (1,1) point 101, and thereafter, the other pilot subcarrier signals are transmitted with a slope of 3. In addition, pilot channel based on a pilot pattern transmitted in the time-frequency domain are represented by

σₛ(j,t)=st+nⱼ(mod N), for j=1, . . . , Nₚ (1)

In Equation (1), σₛ(j,t) denotes a transmission point of a j^{th} pilot channel having a slope ‘s’ at a time ‘t’, and nⱼ is a frequency offset and denotes a point where a first pilot subcarrier signal is separated from the origin of the time-frequency domain. Further, N denotes the total number of subcarriers of the OFDM communication system, and Nₚ denotes the number of pilot channels. Here, the number Nₚ of pilot channels is previously determined in the OFDM communication system, and known by both a transmitter and a receiver.

As a result, for the pilot pattern shown in FIG. 1, a slope ‘s’ is 3 (s=3), a frequency offset nⱼ is 0 (nⱼ=0), the total number N of subcarriers of the OFDM communication system is 11 (N=11), and the number Nₚ of pilot channels is 1 (Nₚ=1).

With reference to FIG. 1, a description has been made of a pilot pattern for an OFDM communication system using one pilot channel. Next, pilot patterns for an OFDM communication system using two pilot channels will be described with reference to FIG. 2.

FIG. 2 is a diagram illustrating points where pilot subcarrier signals based on a particular pilot pattern are transmitted in a common OFDM communication system using two pilot channels.

Before a description of FIG. 2 is given, it is noted that white and shaded circles shown in FIG. 2 represent points where pilot subcarrier signals are actually transmitted, and transmission points of the pilot subcarrier signals are expressed in the form of (time domain, frequency domain). Further, it is assumed in FIG. 2 that a coherence bandwidth 201 is 6 in a frequency domain (i.e. the coherence bandwidth 201 corresponds to 6 subcarriers), and a coherence time 202 is 1 in a time domain (i.e. the coherence time 202 is one OFDM symbol).

As assumed above, because the coherence bandwidth 201 corresponds to 6 subcarriers and the coherence time 202 is one OFDM symbol, a pilot subcarrier signal must be separated by a bandwidth corresponding to a maximum of 6 subcarriers and transmitted for at least each OFDM symbol in order to reflect its channel condition. Alternatively, a plurality of pilot subcarrier signals can be transmitted within the coherence bandwidth 201. In this case, however, less data channel signals are transmitted due to the transmission of the pilot subcarrier signals, resulting in a decrease in the data rate. Therefore, in FIG. 2, only one pilot subcarrier signal is transmitted within the coherence bandwidth 201.

Referring to FIG. 2, there are shown two pilot channels: a first pilot channel and a second pilot channel. For the first pilot channel, a first pilot subcarrier signal is transmitted at a (1,1) point 211, a second pilot subcarrier signal is transmitted at a (2,4) point 212, a third pilot subcarrier signal is transmitted at a (3,7) point 213, a fourth pilot subcarrier signal is transmitted at a (4,10) point 214, a fifth pilot subcarrier signal is transmitted at a (5,2) point 215, a sixth pilot subcarrier signal is transmitted at a (6,5) point 216, a seventh pilot subcarrier signal is transmitted at a (7,8) point 217, and an eighth pilot subcarrier signal is transmitted at a point (8,11) 218. For the second pilot channel, a first pilot subcarrier signal is transmitted at a (1,7) point 221, a second pilot subcarrier signal is transmitted at a (2,10) point 222, a third pilot subcarrier signal is transmitted at a (3,2) point 223, a fourth pilot subcarrier signal is transmitted at a (4,5) point 224, a fifth pilot subcarrier signal is transmitted at a (5,8) point 225, a sixth pilot subcarrier signal is transmitted at a (6,11) point 226, a seventh pilot subcarrier signal is transmitted at a (7,3) point 227, and an eighth pilot subcarrier signal is transmitted at a point (8,6) 228.

As a result, for the first pilot channel, a slope ‘s₁’ is 3 (s₁=3), a frequency offset nⱼ is 0 (nⱼ=0), and the total number N of subcarriers of the OFDM communication system is 11 (N=11). In addition, for the second pilot channel, a slope ‘s₂’ is 3 (s₂=3), a frequency offset nⱼ is 6 (nⱼ=6), and the total number N of subcarriers of the OFDM communication system is 11 (N=11). In FIG. 2, because there are two types of pilot channels represented by white circles and shaded circles, the number Nₚ of pilot channel becomes 2 (Nₚ=2).

With reference to FIG. 2, a description has been made of a pilot pattern for an OFDM communication system using two pilot channels.

When pilot channels are assigned to subcarriers in a time-frequency domain, the point where the subcarriers are to transmit data can undergo a change according to a particular pattern set in each system for identification of the base stations. Even the subcarriers located at the same frequency are transmitted as pilot subcarriers at a particular time and as data subcarriers at another time.

In this case, when a mobile station receives the pilot subcarrier signals and identifies a plurality of base stations, a modulation method becomes complicated because pilot subcarrier signals are transmitted through subcarriers in different points for each of the base stations. In addition, as described above, because the mobile station selectively receives pilot subcarrier signals and data subcarrier signals according to time variation in the same frequency band, the mobile station must determine during demodulation whether pilot subcarrier signals are included in each of frequency bands, for each reception symbol time.

### SUMMARY OF THE INVENTION

It is, therefore, an object of the present invention to provide an apparatus and method for transmitting/receiving a dedicated pilot channel for identification of base stations in an OFDM communication system.

It is another object of the present invention to provide an apparatus and method for assigning a pilot-dedicated frequency band for identification of base stations in an OFDM communication system.

It is further another object of the present invention to provide an apparatus and method for setting a frequency band including a pilot subcarrier as a pseudo pilot subcarrier in a pilot channel for identification of base stations in an OFDM communication system.

The above and other objects are achieved by providing a transmission apparatus of a base station in a wireless communication system that divides an entire frequency band into a plurality of subcarrier bands, transmits reference signals for identifying a plurality of the base stations. The apparatus comprises a pilot pattern generator for receiving parallel-converted data signals, generating reference signals for identifying the base station, and inserting the reference signals into the parallel-converted data signals; a pilot pattern assignment controller for assigning the subcarrier band at which the reference signals are transmitted as a reference signal-dedicated frequency band, and performing a control operation such that no data signal is transmitted at the reference signal-dedicated frequency band; an inverse fast Fourier transform (IFFT) block for performing IFFT on a signal output from the pilot pattern generator; and a transmitter for serial-converting the IFFT-transformed parallel signals and inserting a predetermined guard interval signal into the serial-converted signal.

The above and other objects are achieved by providing a reception apparatus of a mobile station in a wireless communication system that divides an entire frequency band into a plurality of subcarrier bands, transmits reference signals for identifying a plurality of the base stations. The apparatus comprises a receiver for removing a guard interval signal from a predetermined interval of a received signal, and parallel-converting the guard interval-removed signal; a fast Fourier transform (FFT) block for performing FFT on a signal output from the receiver; a pilot extractor for extracting reference signals from among the FFT-transformed signals through bands previously assigned as a reference signal-dedicated frequency band; and a synchronization and channel estimation unit for detecting a reference signal pattern of reference signals extracted by the pilot extractor, and identifying a base station to which the mobile station belongs.

The above and other objects are achieved by providing a, transmission method of a base station in a wireless communication system that divides an entire frequency band into a plurality of subcarrier bands, transmits reference signals for identifying a plurality of the base stations. The method comprises assigning a subcarrier band at which reference signals are transmitted as a frequency band dedicated to the reference signals; and transmitting the reference signals through the assigned reference signal-dedicated frequency band.

The above and other objects are achieved by providing a reception method of a mobile station in a wireless communication system that divides an entire frequency band into a plurality of subcarrier bands, transmits reference signals for identifying a plurality of the base stations. The method comprises removing a guard interval signal from a predetermined interval of a signal received by a mobile station, and parallel-converting the guard interval-removed signal; performing fast Fourier transform (FFT) on the parallel-converted signal; extracting reference signals from among the FFT-transformed signals through bands previously assigned as a reference signal-dedicated frequency band; and detecting a pattern of the extracted reference signals and identifying a base station to which the mobile station belongs.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating points where pilot subcarrier signals based on a particular pilot pattern are transmitted in a conventional OFDM communication system using one pilot channel;

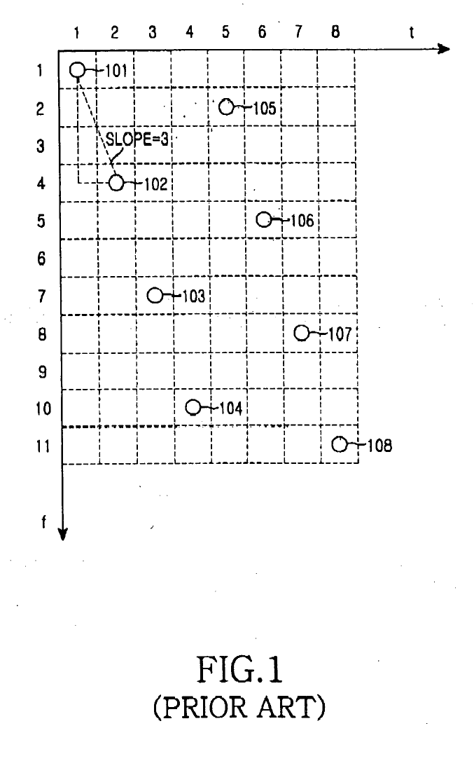

FIG. 2 is a diagram illustrating points where pilot subcarrier signals based on a particular pilot pattern are transmitted in a conventional OFDM communication system using two pilot channels;

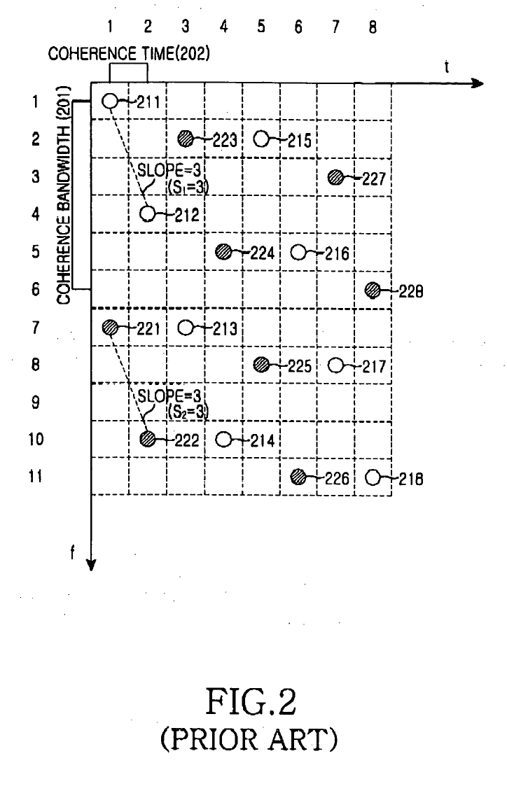

FIG. 3 is a diagram illustrating a method for assigning a subcarrier in a pilot pattern in a time-frequency domain according to an embodiment of the present invention;

FIG. 4 is a flowchart illustrating a procedure for assigning subcarriers in a pilot pattern by a base station according to an embodiment of the present invention;

FIG. 5 is block diagram illustrating an apparatus for setting a pilot-dedicated frequency band for generation of a pilot pattern according to an embodiment of the present invention; and

FIG. 6 is a block diagram illustrating an OFDM communication system according to an embodiment of the present invention.

### DETAILED DESCRIPTION OF THE PREFERRED EMBODIMENT

A preferred embodiment of the present invention will now be described in detail with reference to the annexed drawings. In the following description, a detailed description of known functions and configurations incorporated herein has been omitted for conciseness.

The present invention proposes a method for generating a pilot pattern for identification of a base station (BS) in a communication system employing an Orthogonal Frequency Division Multiplexing (OFDM) scheme (hereinafter referred to as an “OFDM communication system”).

In particular, the present invention proposes a method for assigning subcarriers in a particular band as a pilot-dedicated (or pilot-only) frequency band for transmitting a pilot subcarrier for generating and transmitting the pilot pattern.

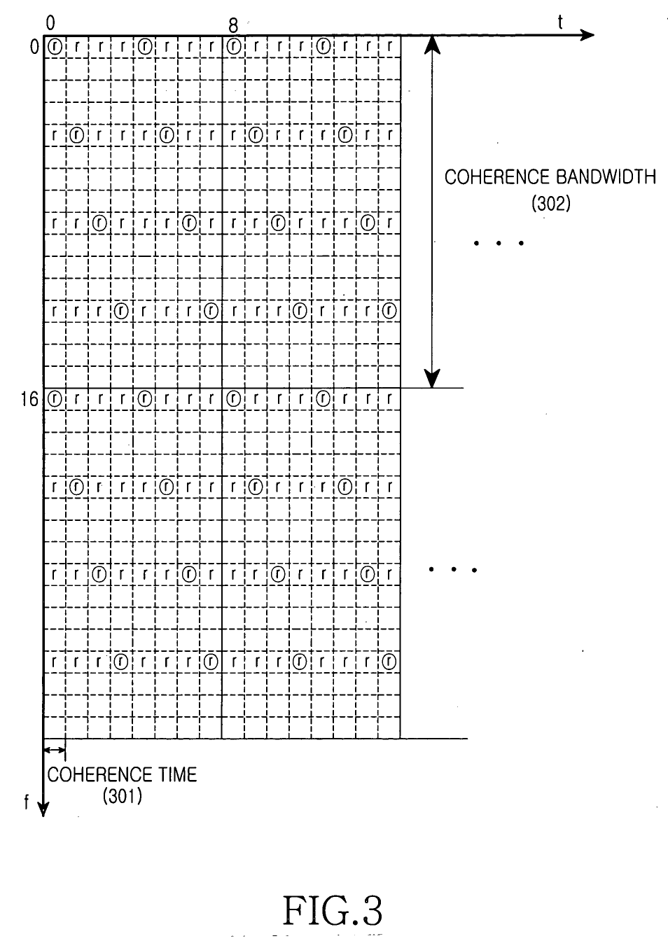

A method for assigning the pilot-dedicated frequency band proposed in the present invention will be described herein below with reference to FIG. 3.

FIG. 3 is a diagram illustrating a method for assigning a subcarrier in a pilot pattern in a time-frequency domain according to an embodiment of the present invention. Before a description of FIG. 3 is given, a process of transmitting pilot subcarriers will be described. As described above, in an OFDM communication system, a transmitter (or a base station) transmits pilot subcarrier signals (hereinafter referred to as “pilot channel signals”) to a receiver (or a mobile station). The base station transmits data subcarrier signals (hereinafter referred to as “data channel signals”) together with the pilot channel signals.

Here, the reason for transmitting the pilot channel signals by the base station is for synchronization acquisition, channel estimation, and base station identification. The pilot channel signals serve as a training sequence, and are used for performing channel estimation between a transmitter and a receiver. Further, mobile stations can identify their base stations using the pilot channel signals.

Points where the pilot channel signals are transmitted are predetermined by the transmitter and the receiver. The pilot pattern is a pattern in which pilot channel signals transmitted by the base station are generated. That is, the pilot pattern is distinguished by a slope of the pilot channel signals and a transmission start point of the pilot channel signals. Therefore, the OFDM- communication system should be designed such that base stations have their own predetermined pilot patterns for their identification.

In addition, the pilot pattern is generated by taking into account a coherence bandwidth and a coherence time. As described in the related art section, the coherence bandwidth represents a maximum bandwidth where it can be assumed that a channel is constant, in the frequency domain. The coherence time represents a maximum time where it can be assumed that a channel is constant, in the time domain.

Because it can be assumed that a channel is equal within the coherence bandwidth and coherence time, even though only one pilot channel signal is transmitted within the coherence bandwidth and coherence time, it is sufficient for synchronization acquisition, channel estimation, and base station identification. As a result, it is possible to maximize transmission of data channel signals, thereby contributing to improvement in entire system performance.

Therefore, in a common OFDM communication system, a minimum frequency interval for transmitting pilot channel signals is called a coherence bandwidth, and a maximum time interval, or a OFDM symbol time interval, for transmitting the pilot channel signals is called a coherence time. That is, the pilot pattern should also be generated considering the coherence bandwidth and the coherence time.

Referring to FIG. 3, subcarriers denoted by white circles represent points where pilot channel signals are actually transmitted, and the transmission points of the pilot channel signals are expressed in terms of (time domain, frequency domain) as described above. Further, it is assumed in FIG. 3 that a coherence bandwidth 302 is 16 in a frequency domain (i.e. the coherence bandwidth 302 corresponds to 16 subcarriers), and a coherence time 301 is 1 in a time domain (i.e. the coherence time 301 is one OFDM symbol).

In a time-frequency domain of FIG. 3, a first pilot channel signal is transmitted at (0,0) and (0,16), a second pilot channel signal is transmitted at (1,4) and (1,20), a third pilot channel signal is transmitted at (2,8) and (2,24), a fourth pilot channel signal is transmitted at (3,12) and (3,28), a fifth pilot channel signal is transmitted at (4,0) and (4,16), a sixth pilot channel signal is transmitted at (5,4) and (5,20), a seventh pilot channel signal is transmitted at (6,8) and (6,24), and an eighth pilot channel signal is transmitted at (7,12) and (7,28). The pilot channel signals are continuously transmitted in the above pattern when a mobile station exchanges the pilot channel signals with the same base station.

Conventionally, however, the pilot channel signals are transmitted at predetermined points of the time-frequency domain (i.e. points of subcarriers where pilot channel signals must be transmitted at a particular time are determined before transmission thereof), and data channel signals are transmitted at other domains. The pilot channel signals, as described above, are transmitted for synchronization, channel estimation and base station identification, and the data channels transmit the information that the base station and the mobile station actually desire to transmit and receive.

In the present invention, a particular frequency band where the pilot channel signals are transmitted is assigned as a pilot-dedicated frequency band. That is, subcarriers assigned to the pilot-dedicated frequency band do not transmit data channel signals, and are left as a dedicated channel domain for the pilot transmission.

For example, at a first transmission time (t=0) of FIG. 3, pilot channel signals are transmitted at (0,0) and (0,16) as described above. Therefore, according to the present invention, an entire 0^{th} frequency band which is a subfrequency band corresponding to (0,0) is set as a pilot-dedicated frequency band. That is, because (1,0), (2,0), (3,0), . . . , (n,0) are pilot-dedicated frequency bands, no data channel signal is transmitted at these frequency bands. In FIG. 3, subcarrier transmission spaces in the time-frequency domain which are set as the pilot-dedicated frequency bands are represented by ‘r’. Therefore, the same frequency bands (0^{th} bands) after the (0,0) are all represented by ‘r’, and the spaces denoted by ‘r’, where no data channel signal is transmitted, are left as reserved domains. In the spaces set as the pilot-dedicated frequency band, domains (denoted by ‘r’) left as reserved domains except the domains (denoted by circled ‘r’) where pilot channel signals are actually transmitted, are defined as “pseudo pilot domains.” In the pseudo pilot domains, pilot channel signals are not transmitted but simply occupied. In addition, domains where the pilot channel signals are transmitted will be defined as “pilot transmission domains.”

In the present invention, a pilot-dedicated frequency band is a subcarrier band including both the pilot transmission domains and the pseudo pilot domains. The pilot-dedicated frequency band transmits no data channel signal. A separate channel other than a data channel can be formed and transmitted. Because no data channel signal is transmitted at the pilot-dedicated frequency band, data channel signals do not have to be demodulated for the pilot-dedicated frequency band. Even when the receiver extracts pilot channel signals, it is not necessary to perform demodulation on the entire frequency band. Therefore, it is possible to perform demodulation on only the pilot-dedicated frequency band to detect a pilot pattern.

In the first time domain, a 16^{th} frequency band which is a subfrequency band corresponding to (0,16) is also set as a pilot-dedicated frequency band in the same manner. Because (1,16), (2,16), (3,16), . . . , (n,16) are pilot-dedicated frequency bands, no data channel signal is transmitted at these frequency bands. Similar to the 0^{th} frequency band, the 16^{th} frequency band is also a pilot-dedicated frequency band including pilot transmission domains (denoted by circled ‘r’) and pseudo pilot domains (denoted by ‘r’).

After a pilot-dedicated frequency band is set for the first transmission time, pilot channel signals are transmitted at (1,4) and (1,20) at the next transmission time (t=1). Therefore, like in the first transmission time, according to the present invention, an entire 4^{th} frequency band which is a subfrequency band corresponding to (1,4) is set as a pilot-dedicated frequency band. Because (1,4), (2,4), (3,4), . . . , (n,4) are pilot-dedicated frequency bands, no data channel signal is transmitted at these frequency bands.

In the same method, in a next time domain of the first time domain, a 20^{th} frequency band which is a subfrequency band corresponding to (1,20) is also set as a pilot-dedicated frequency band. Because (1,20), (2,20), (3,20), . . . , (n,20) are pilot-dedicated frequency bands, no data channel signal is transmitted at these frequency bands.

A pilot-dedicated frequency band previously set in the first time domain (t=0) is continuously available even in the next time domain (t=1). Therefore, in a second time domain, 2 pilot-dedicated frequency bands (4^{th} band and 20^{th} band) are newly added to the 2 pilot-dedicated frequency bands (0^{th} band and 16^{th} band) previously set in the first time domain, so a total of 4 subfrequency bands are set as pilot-dedicated frequency bands. From the next time domain, data channel signals are not transmitted and pilot subcarriers or pseudo pilot subcarriers (e.g., subcarriers where no information is transmitted) are transmitted for the 4 pilot-dedicated frequency bands. Thus, the mobile station is not required to perform a data demodulation process on the pilot-dedicated frequency bands, contributing to simplification of the demodulation process.

In the same method, in a 3^{rd} time domain (t=2) and a 4^{th} time domain (t=3), 8^{th}, 12^{th}, 24^{th} and 28^{th} subfrequency bands are set as pilot-dedicated frequency bands by pilot subcarriers of (2,8), (2,24), (3,12) and (3,28).

Referring to FIG. 3, the pilot subcarriers transmitted after a 5^{th} time domain (t=4) are transmitted through the previously set pilot-dedicated frequency band. It is not necessary to add a new pilot-dedicated frequency band, and the pilot channel signals can easily be demodulated through the previously set pilot-dedicated frequency band. Data channel signals are transmitted at the remaining frequency bands (1^{st} to 3^{rd} bands, 5^{th} to 7^{th} bands, 9^{th} to 11^{th} bands, 13^{th} to 15^{th} bands, 17^{th} to 19^{th} bands, 21^{st} to 23^{rd} bands, 25^{th} to 27^{th} bands, and 29^{th} to 31^{st} bands) except the pilot-dedicated frequency band.

At the preset pilot-dedicated frequency band, because only pilot subcarrier signals or pseudo pilot subcarriers are transmitted and data channel signals are not transmitted, it is not necessary to demodulate the pilot-dedicated frequency band in demodulating data channels.

When the pilot pattern is changed (for example, when the setting of a pilot pattern is changed according to a change in the base station), the pilot-dedicated frequency band is changed, and a pilot-dedicated frequency band is newly set in the above-described manner.

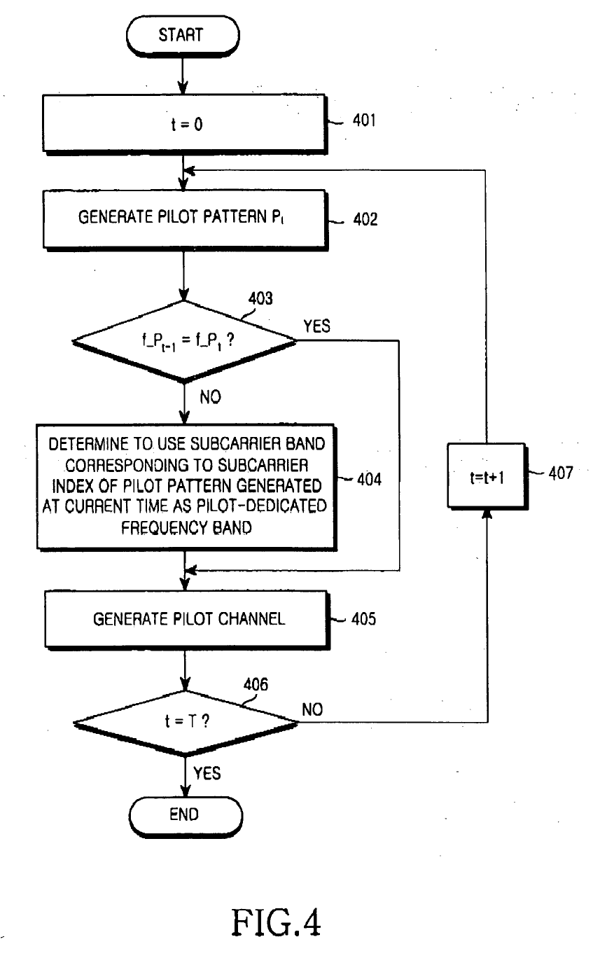

FIG. 4 is a flowchart illustrating a procedure for assigning by a base station subcarriers in a pilot pattern according to an embodiment of the present invention. Before a description of FIG. 4 is given, it should be noted that a controller for an upper layer of an OFDM communication system assigns a pilot pattern to each of the base stations constituting the OFDM communication system by performing the operation of FIG. 4. Further, the controller provides each of the base stations with information related to a pilot pattern assigned to each of the base stations. The controller also provides each of the mobile stations with the same information.

The base stations transmit the pilot channel signals to identify the base stations according to pilot patterns assigned thereto, and the mobile stations identify their base station using a pilot pattern corresponding to received pilot channel signals.

Referring to FIG. 4, in step 401, t=0 denotes an index 0 on a time axis in FIG. 3, and signifies the beginning of the transmission of data. It will be assumed herein that a time axis size of 1 in FIG. 3 is one OFDM symbol length.

In step 401, the base station starts the data transmission at t=0, and then proceeds to step 402. In step 402, the base station generates a pilot pattern Pₜ corresponding to the time t=0, and then proceeds to step 403. In step 403, the base station compares a frequency point of a pilot pattern Pₜ₋₁ generated at a previous time ‘t-1’ with a frequency point of a pilot pattern Pₜ generated at a current time ‘t’, and proceeds to step 404 if the two pilot patterns are different in their frequency point, and proceeds to step 405 if the two pilot patterns are equal in their frequency point. Here, f_Pₜ₋₁ and f_Pₜ mean frequency points, or subcarrier indexes, of pilot patterns generated at time domains ‘t-1’ and ‘t’, respectively. When data transmission is first made (t=0), it is preferable to omit the comparison step because there is no frequency point to be compared. In step 404, the base station determines to use a frequency point, or a pilot subcarrier index, of a pilot pattern generated at a current time, and then proceeds to step 405.

In step 405, the base station generates a pilot channel at a subcarrier band corresponding to the determined pilot subcarrier index, and then proceeds to step 406. In step 406, the base station determines if a pilot channel is generated until a predetermined pilot channel generation end time T. If it is determined that a pilot channel is generated until the pilot channel generation end time T, the base station ends the procedure without generating any more pilot channel. However, if the current time has not reached the pilot channel generation end time, the base station proceeds to step 407. In step 407, the base station increases a time index by 1, and then returns to step 402.

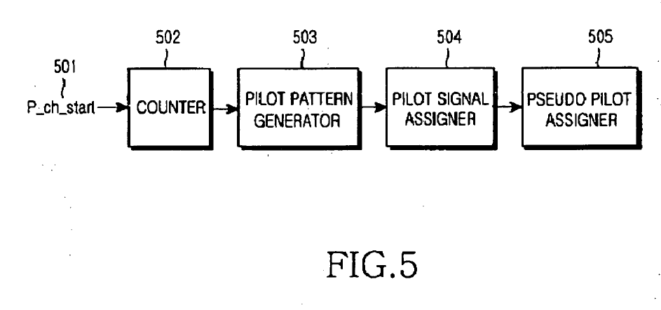

FIG. 5 is block diagram illustrating an apparatus for setting a pilot-dedicated frequency band for generation of a pilot pattern according to an embodiment of the present invention. Referring to FIG. 5, an apparatus according to an embodiment of the present invention is comprised of a counter 502, a pilot pattern generator 503, a pilot signal assigner 504, and a pseudo pilot assigner 505.

A control signal P_ch_start 501 is input to the counter 502. The control signal 501 represents a point where a base station starts its transmission of a pilot channel. The control signal 501 input to the counter 502 initializes the counter 502 to a start state (t=0), and then increases the counter 502 one by one.

The pilot pattern generator 503 receiving time information from the counter 502 generates a pilot pattern corresponding to the time information. Pilot subcarriers to be used as a pilot-dedicated frequency band are determined according to the pilot pattern generated by the pilot pattern generator 503. The pilot signal assigner 504 assigns a pilot signal per particular time (coherence time) of the determined subcarrier index. The pseudo pilot assigner 505 assigns a pseudo pilot signal at a time other than the time when the pilot signal is assigned. Referring to FIG. 3, based on the generated pilot pattern, the pilot signal assigner 504 recognizes that a 0^{th} subcarrier index is a pilot-dedicated frequency band. Therefore, the pilot signal assigner 504 assigns a pilot channel signal at a coherence time 0 of the 0^{th} subcarrier, and the pseudo pilot assigner 505 assigns pseudo pilots at a coherence time 1 to a coherence time 3.

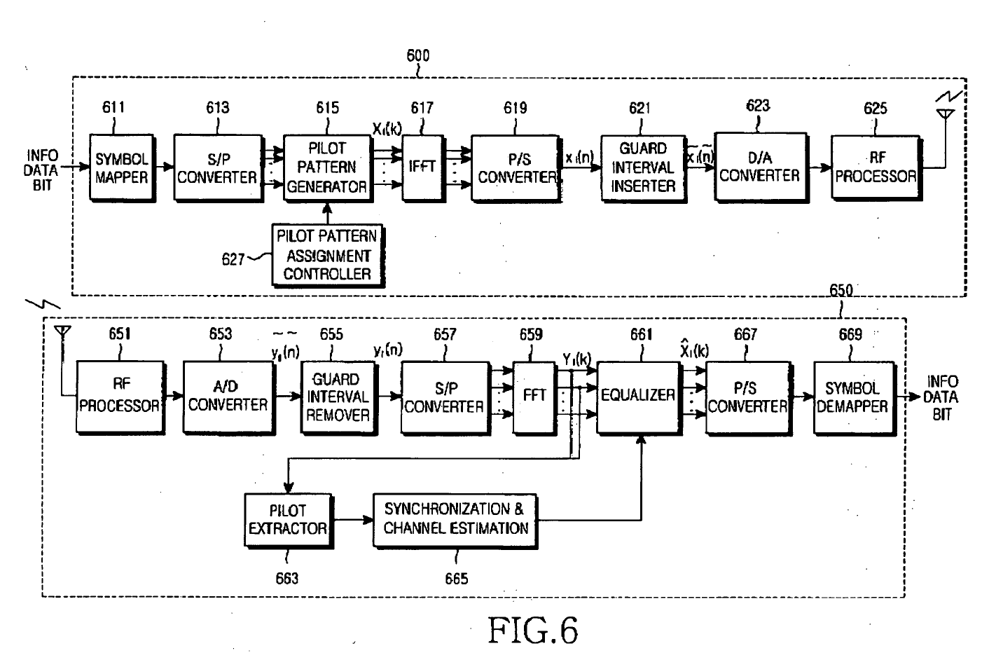

An apparatus for assigning subcarriers in a pilot pattern has been described so far with reference to FIG. 5. Next, with reference to FIG. 6, a description will be made of a base station apparatus and a mobile station apparatus for identifying base stations using a pilot-dedicated frequency band according to an embodiment of the present invention.

FIG. 6 is a block diagram illustrating an OFDM communication system ccording to an embodiment of the present invention. Referring to FIG. 6, the OFDM communication system is comprised of a transmission apparatus, or a base station apparatus 600, and a reception apparatus, or a mobile station apparatus 650.

First, the base station apparatus 600 will be described. The base station apparatus 600 is comprised of a symbol mapper 611, a serial-to-parallel (S/P) converter 613, a pilot pattern generator 615, an inverse fast Fourier transform (IFFT) block 617, a parallel-to-serial (P/S) converter 619, a guard interval inserter 621, a digital-to-analog (D/A) converter 623, a radio frequency (RF) processor 625, and a pilot pattern assignment controller 627.

When there are information data bits to be transmitted, the information data bits are input to the symbol mapper 611. The symbol mapper 611 modulates the input information data bits in a predetermined modulation scheme for symbol mapping, and outputs the symbol-mapped data bits to the serial-to-parallel converter 613. Here, quadrature phase shift keying (QPSK) or 16-ary quadrature amplitude modulation (16 QAM) can be used as the modulation scheme. The serial-to-parallel converter 613 parallel-converts serial modulation symbols output from the symbol mapper 611, and outputs the parallel-converted modulation symbols to the pilot pattern generator 615.

The pilot pattern generator 615 receives the parallel-converted modulation symbols output from the serial-to-parallel converter 613, generates pilot subcarriers according to a pilot pattern assigned to the base station in the above-described manner, inserts the generated pilot subcarriers into the parallel-converted modulation symbols, and outputs the pilot subcarrier-inserted modulation symbols to the IFFT block 617.

The pilot pattern assignment controller 627 assigns a subfrequency band corresponding to the pilot subcarriers as a pilot-dedicated frequency band according to the pilot pattern. As described above, after the pilot-dedicated frequency band is assigned, no data channel is transmitted at the assigned pilot-dedicated frequency band.

The signals output from the pilot pattern generator 615, i.e. parallel signals including the modulation symbols and the pilot symbols corresponding to pilot patterns, are represented by X₁(k).

The IFFT block 617 performs N-point IFFT on the signals X₁(k) output from the pilot pattern generator 615, and outputs the resultant signals to the parallel-to-serial converter 619. The parallel-to-serial converter 619 serial-converts the signals output form the IFFT block 617, and outputs the serial-converted signals to the guard interval inserter 621.

The signal output from the parallel-to-serial converter 619 is represented by x₁(n). The guard interval inserter 621 receives the signal output from the parallel-to-serial converter 619, inserts a guard interval therein, and outputs the guard interval-inserted signal to the digital-to-analog converter 623. The guard interval is inserted to remove interference between a previous OFDM symbol transmitted at a previous OFDM symbol time and a current OFDM symbol to be transmitted at a current OFDM symbol time in an OFDM communication system.

For the guard interval, null data is inserted for a predetermined interval. If a receiver does not correctly estimate a start point of an OFDM symbol, interference occurs between subcarriers, causing an increase in error probability of a received OFDM symbol. In order to solve such a problem, a cyclic prefix method or a cyclic postfix method is used. In the cyclic prefix method, a predetermined number of last bits of an OFDM symbol in a time domain are copied and inserted into a valid OFDM symbol. In the cyclic postfix method, a predetermined number of first bits of an OFDM symbol in a time domain are copied and inserted into a valid OFDM symbol. A signal output from the guard interval inserter 621 is represented by \tilde{X}₁(ñ), and the signal \tilde{X}₁(ñ) output from the guard interval inserter 621 becomes one OFDM symbol.

The digital-to-analog converter 623 analog-converts the signal output from the guard interval inserter 621, and outputs the analog-converted signal to the RF processor 625. The RF processor 625, which includes a filter and a front-end unit, RF-processes the signal output from the digital-to-analog converter 623 such that the signal can be transmitted over the air, and transmits the RF-processed signal over the air via an antenna.

Next, the mobile station apparatus 650 will be described. The mobile station apparatus 650 is comprised of an RF processor 651, an analog-to-digital (A/D) converter 653, a guard interval remover 655, a serial-to-parallel (S/P) converter 657, a fast Fourier transform (FFT) block 659, an equalizer 661, a pilot extractor 663, a synchronization & channel estimation unit 665, a parallel-to-serial (P/S) converter 667, and a symbol demapper 669.

The signal transmitted by the base station apparatus 600 is received via an antenna of the mobile station apparatus 650. The received signal experiences a multipath channel H₁(k) and has a noise component \tilde{W}₁(ñ). The signal received via the antenna is input to the RF processor 651, and the RF processor 651 down-converts the received signal into an intermediate frequency (IF) signal, and outputs the IF signal to the analog-to-digital converter 653. The analog-to-digital converter 653 digital-converts an analog signal output from the RF processor 651, and outputs the digital-converted signal to the guard interval remover 655. Here, the digital signal output from the analog-to-digital converter 653 will be referred to as \tilde{y}₁(ñ).

The guard interval remover 655 removes a guard interval from the signal \tilde{y}₁(ñ) output from the analog-to-digital converter 653, and outputs the resultant signal to the serial-to-parallel converter 657. Here, the signal output from the guard interval remover 655 will be called y₁(n). The serial-to-parallel converter 657 parallel-converts the serial signal y₁(n) output from the guard interval remover 655, and outputs the resultant signal to the FFT block 659. The FFT block 659 performs N-point FFT on the signal output from the serial-to-parallel converter 657, and outputs the resultant signal to the equalizer 661 and the pilot extractor 663. Here, the signal output from the FFT block 659 will be called Y₁(k). The equalizer 661 performs channel equalization on the signal Y₁(k) output from the FFT block 659, and outputs a resultant signal to the parallel-to-serial converter 667. Here, the signal output from the equalizer 661 will be called \hat{X}₁(k). The parallel-to-serial converter 667 serial-converts the parallel signal \hat{X}₁(k) output from the equalizer 661, and outputs a resultant signal to the symbol demapper 669. The symbol demapper 669 demodulates the signal output from the parallel-to-serial converter 667 using a demodulation scheme corresponding to the modulation scheme used in the base station apparatus 600, and outputs a resultant signal as received information data bits.

Further, the signal Y₁(k) output from the FFT block 659 is input to the pilot extractor 663, and the pilot extractor 663 extracts pilot symbols from the signal Y₁(k) output from the FFT block 659, and outputs the extracted pilot symbols to the synchronization & channel estimation unit 665. According to the present invention, the pilot extractor 663 can extract the pilot symbols only for preset pilot-dedicated frequency bands. As described above, because the pilot channel is transmitted only at preset pilot-dedicated frequency bands after a lapse of a predetermined time, it is not necessary to check pilot channels at other subfrequency bands except the pilot-dedicated frequency bands.

The synchronization & channel estimation unit 665 performs synchronization and channel estimation on the pilot symbols output from the pilot extractor 663, and outputs the result to the equalizer 661. The synchronization & channel estimation unit 665, as described above, includes pilot patterns for respective base stations constituting the OFDM communication system in the form of a table, determines to which pilot pattern from among the pilot patterns the pilot symbols output from the pilot extractor 663 are matched, and determines a base station corresponding to the matched pilot pattern as a base station to which the mobile station apparatus 650 itself belongs. Further, the synchronization & channel estimation unit 665 detects a pilot pattern (or slope of a pilot pattern) for each pilot subcarrier of an OFDM communication system, to thereby identify the base stations.

The equalizer 661 performs channel equalization on the signal Y₁(k) output from the FFT block 659, and outputs a resultant signal to the parallel-to-serial converter 657. Here, the signal output from the equalizer 661 will be called \hat{X}₁(k). The parallel-to-serial converter 667 serial-converts the parallel signal \hat{X}₁(k) output from the equalizer 661, and outputs a resultant signal to the symbol demapper 669. The symbol demapper 669 demodulates the signal output from the parallel-to-serial converter 667 using a demodulation scheme corresponding to the modulation scheme used in the base station apparatus 600, and outputs a resultant signal as received information data bits.

As is understood from the foregoing description, some subcarriers of a pilot channel provided in an OFDM communication system are assigned as a pilot-dedicated frequency band, so a receiver can easily receive a pilot channel. In addition, according to the present invention, when a channel is estimated using a pilot channel, a pilot signal is transmitted at a point known by both a transmitter and a receiver, thereby simplifying a channel estimation process.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A transmission method of a base station in a wireless communication system that divides an entire frequency band into a plurality of subcarrier bands, transmits reference signals for identifying a plurality of the base stations, the method comprising the steps of:
assigning a subcarrier band at which reference signals are transmitted as a frequency band dedicated to the reference signals; and
transmitting the reference signals through the assigned reference signal-dedicated frequency band.

2. The transmission method of claim 1, further comprising the step of setting a predetermined reference signal pattern for identifying a base station.

3. The transmission method of claim 1, wherein the reference signal-dedicated frequency band is assigned when the reference signal is first transmitted at each subcarrier band.

4. The transmission method of claim 1, wherein the reference signal is transmitted according to a predetermined time interval.

5. The transmission method of claim 4, wherein no data signal is transmitted at a reserved time other than the time when the reference signal is transmitted.

6. A reception method of a mobile station in a wireless communication system that divides an entire frequency band into a plurality of subcarrier bands, transmits reference signals for identifying a plurality of the base stations, the method comprising the steps of:
removing a guard interval signal from a predetermined interval of a signal received by a mobile station, and parallel-converting the guard interval-removed signal;
performing fast Fourier transform (FFT) on the parallel-converted signal;
extracting reference signals from among the FFT-transformed signals through bands previously assigned as a reference signal-dedicated frequency band; and
detecting a pattern of the extracted reference signals and identifying a base station to which the mobile station belongs.

7. The reception method of claim 6, wherein the reference signal-dedicated frequency band is set by a base station for a subcarrier band at which the reference signal is transmitted.

8. The reception method of claim 7, wherein the reference signal-dedicated frequency band is reserved such that the reference signal is transmitted according to a time interval predetermined for transmission of the reference signals and data signals are not transmitted at a remaining time.

9. The reception method of claim 6, wherein the base station is identified by a reference signal pattern in a time-frequency domain of the transmitted reference signals.

10. The reception method of claim 6, wherein the reference signal-dedicated frequency band is assigned when the reference signal is first transmitted at each subcarrier band.

11. A transmission apparatus of a base station in a wireless communication system that divides an entire frequency band into a plurality of subcarrier bands, transmits reference signals for identifying a plurality of the base stations, the apparatus comprising:
a pilot pattern generator for receiving parallel-converted data signals, generating reference signals for identifying the base station, and inserting the reference signals into the parallel-converted data signals;
a pilot pattern assignment controller for assigning the subcarrier band at which the reference signals are transmitted as a reference signal-dedicated frequency band, and performing a control operation such that no data signal is transmitted at the reference signal-dedicated frequency band;
an inverse fast Fourier transform (IFFT) block for performing IFFT on a signal output from the pilot pattern generator; and
a transmitter for serial-converting the IFFT-transformed parallel signals and inserting a predetermined guard interval signal into the serial-converted signal.

12. The transmission apparatus of claim 11, wherein the transmitter comprises:
a parallel-to-serial converter for serial-converting the IFFT-transformed parallel signals;
a guard interval inserter for inserting the guard interval signal into the serial-converted signal output from the parallel-to-serial converter; and
a radio frequency (RF) processor for RF-processing a signal output from the guard interval inserter.

13. The transmission apparatus of claim 11, wherein the pilot pattern assignment controller assigns the subcarrier band as a reference signal-dedicated frequency band when a reference signal is first transmitted at each of the subcarrier bands.

14. The transmission apparatus of claim 11, wherein the base station is identified by a pattern in a time-frequency domain of the transmitted reference signals.

15. A reception apparatus of a mobile station in a wireless communication system that divides an entire frequency band into a plurality of subcarrier bands, transmits reference signals for identifying a plurality of the base stations, the apparatus comprising:
a receiver for removing a guard interval signal from a predetermined interval of a received signal, and parallel-converting the guard interval-removed signal;
a fast Fourier transform (FFT) block for performing FFT on a signal output from the receiver;
a pilot extractor for extracting reference signals from among the FFT-transformed signals through bands previously assigned as a reference signal-dedicated frequency band; and
a synchronization and channel estimation unit for detecting a reference signal pattern of reference signals extracted by the pilot extractor, and identifying a base station to which the mobile station belongs.

16. The reception apparatus of claim 15, wherein the receiver comprises:
a guard interval remover for removing the guard interval signal from the received signal; and
a serial-to-parallel converter for parallel-converting the guard interval-removed signal.

17. The reception apparatus of claim 15, wherein the reference signal pattern is a pattern for a point in a time-frequency domain of reference signals transmitted at the subcarrier bands.

18. The reception apparatus of claim 15, wherein the subcarrier band is assigned as a reference signal-dedicated frequency band when a reference signal is first transmitted at each of subcarrier bands.

19. The reception apparatus of claim 15, wherein the base station is identified by a pattern in a time-frequency domain of the transmitted reference signals.

20. The reception apparatus of claim 15, wherein no data signal is transmitted through the dedicated frequency band at a time when the pilot signal is not transmitted after assignment of the dedicated frequency band.
